(19) United States
(12) Patent Application Publication
(10) Pub. No.: US 2014/0067659 A1
(43) Pub. Date: Mar. 6, 2014

(54) SYSTEM AND METHOD FOR CHARITABLE DONATION HANDLING

(71) Applicant: David G. Drake, Indialantic, FL (US)

(72) Inventor: David G. Drake, Indialantic, FL (US)

(21) Appl. No.: 13/963,760

(22) Filed: Aug. 9, 2013

Related U.S. Application Data
(60) Provisional application No. 61/694,580, filed on Aug. 29, 2012.

(51) Int. Cl. G06Q 30/02

(52) U.S. Cl. CPC G06Q 30/0279
USPC 705/39

(57) ABSTRACT

A system for processing and filtering donation information received from a donor, the system having a processor. Data indicative of a donation request transmitted to the processor over the internet. A database stores the data that includes a plurality of fields. A funds transfer request generated based on the data and associated with an entity identifier is generated by software executing on the processor. The software compares the address of the entity with the address field to generate a first data set having a plurality of records. Records may include address field when the entity and donor are from the same state, records exclude address field when entity and donor address are of different states. The data set is associated with the entity by the entity identifier and is accessible by a computer associated with the entity identifier.

### FIELD OF THE INVENTION

The present invention relates to charitable fundraising, and more particularly online fundraising and fundraising across multiple states.

### BACKGROUND OF THE INVENTION

There are many registered charities and non-profit organizations that raise money to help support a variety of causes, events or movements. In order to become a registered charity in the United States, organizations typically obtain a registration and tax identification to solicit funds as a non-profit or charitable organization. Laws of the United States and laws of individual states will typically govern the reporting requirements of each charity. When a charity organizes, the process is typically done in the state where that charity has its headquarters. The registration typically requires the charity to file an annual tax return. This return typically requires reporting of donations received.

Many charities will solicit donations from jurisdictions outside where they are organized. For example, a Florida non-profit organization may wish to solicit donations from potential donors in both Florida and other states. The registration of the Florida organization allows for the solicitation from Florida residents. Solicitations outside the state of Florida, may require that the charity register to solicit from residents of their jurisdiction. Along with this registration, each jurisdiction typically requires reporting of donations.

The use of the Internet allows charities to easily reach large populations of potential donors outside their jurisdiction, without the costs of mailing and printing flyers and pamphlets. Additionally, many donors are more willing to send money through credit cards or other electronic transactions, rather than mailing a check. But, with the registration and reporting requirements of each state, the costs of doing business in additional states may outweigh the benefits of registration.

It is therefore desirable to provide a donation handling system that overcomes the disadvantages of the prior art. An object of the present invention is to provide a system which will allow a charity to collect donations in states outside their home state, without requiring the burdensome costs of registering to solicit in each state. Another object of the present invention is to provide a centralized location or portal for a donor to manage and track annual donations. Yet another object of the present invention is to provide a system that allows for charities to engage their contacts and promote their charitable mission to their contacts.

### SUMMARY OF THE INVENTION

These and other objects are achieved by providing a system for processing and filtering donation information received from a donor having a processor. Data transmitted to the processor over the internet and indicative of a donation request. A database stores data, the data including a number of fields. The fields can include name, donation amount, address and electronic communication address. A funds transfer request generated by software executing on the processor is generated based on the data and associated with an entity identifier. An address of the entity compared with the address field by the software to generate a first data set having a plurality of records. Each record includes address field when an address of the entity and the address field include the same state. When the address of the entity and the address field include different states, the records excludes address field. The first data set is associated with the entity by the entity identifier, and is accessible by a computer associated with the entity identifier.

The system can include fee records stored in a database, each fee record corresponding to a transaction fee associated with an amount of a funds transfer request. The donation amount field is compared with the plurality of fee records by the software to determine the transaction fee associated with the donation amount.

The fee records stored in a database, can correspond to a transaction fee associated with an amount of a funds transfer request and associated with a different funds transfer processors. The software compares the donation amount field with the plurality of records to determine the transaction fee associated with the donation amount for each funds transfer processor to create transaction fee data and to generate a request. The request transmitted to a web browser of a donor computer.

The transaction fee data is displayed on said website, and one of the funds transfer processors is user selectable.

A request generated by the software is transmitted to the web server for display, the request requesting a increase of said donation amount based on said transaction fee. The software receives a response and the donation request is modified by the software based on the response.

The website is accessible based on the entity identifier. The entity identifier associated with the first data set. The website receiving content from an entity computer for transmission to the electronic communications address associated with each record. The computer accessing the data set can be an entity computer.

Content is transmitted to the processor by the computer. A communication is generated based on the content and the data and transmitted to a plurality of electronic communication addresses associated with the entity identifier.

The system for processing and filtering donation information received from donors has a processor with software executing thereon. An interface in communication with a donor computer via a web server, the interface for selecting one or more entities. A database stores a plurality of data sets received from a plurality of donor computers each data set indicative of one or more donations, each donation associated with a donor identifier and an entity identifier. Each data set includes a plurality of fields, the fields including at least name, donation amount, address and electronic communication address. The software generates a donation receipt based on each data set associated with the donor identifier. The database stores each donation receipt and is accessible by a donor computer.

The receipt can be is compliant with Internal Revenue Service requirements for reporting a charitable donation.

The receipt generated by said software can include each donation associated with the donor identifier during a calendar year, the receipt transmitted to the donor computer. The receipt can be compliant with Internal Revenue Service requirements, and the software can automatically transmit the donation receipt on an annual basis.

The web server receives a receipt request and the software generates the receipt in response to the receipt request. The web server is accessible based on the donor identifier for transmission of the receipt.

The present invention contemplates a method for managing charitable contributions with a website having the steps of, providing a database, providing a web server in communication the database and having software executing thereon. Receiving data transmitted to the web server from a donor computer, the data indicative of a donation request, the data received by the database. Comparing an address of said entity with an address field of the data via the software. Generating a plurality of records via the software to create a first data set, each record including address field when an address of the entity and the address field include the same state, and each record excluding address field when address of said entity and address field include different states. Associating the first data set with the entity by the entity identifier, and transmitting the first data set to a web server, the first data set accessible based on an entity identifier.

The method can further include receiving a receipt request via a donor computer, the request including a donor identifier. Generating a receipt based on the donor identifier. Transmitting the receipt to the web server. The donor identifier can be the electronic communication address.

The method can further include steps of transmitting a communication generated by the software to an electronic communication address associated with the donor identifier. The data can include: name, address, electronic communication address and donation amount.

### BRIEF DESCRIPTION OF THE DRAWINGS

FIG. 1 shows how donations are processed and data is processed.

FIG. 2 is a flow chart showing how the data of FIG. 1 is collected. By registering with the provider, the charity is preregistered with a third party transaction processor.

FIG. 3 is a flow chart showing how the transaction fee shown in FIGS. 1 and 2 is calculated.

FIG. 4 shows how information collected in FIGS. 1 and 2 is processed and shielded to comply with solicitation requirements.

### DETAILED DESCRIPTION OF THE INVENTION

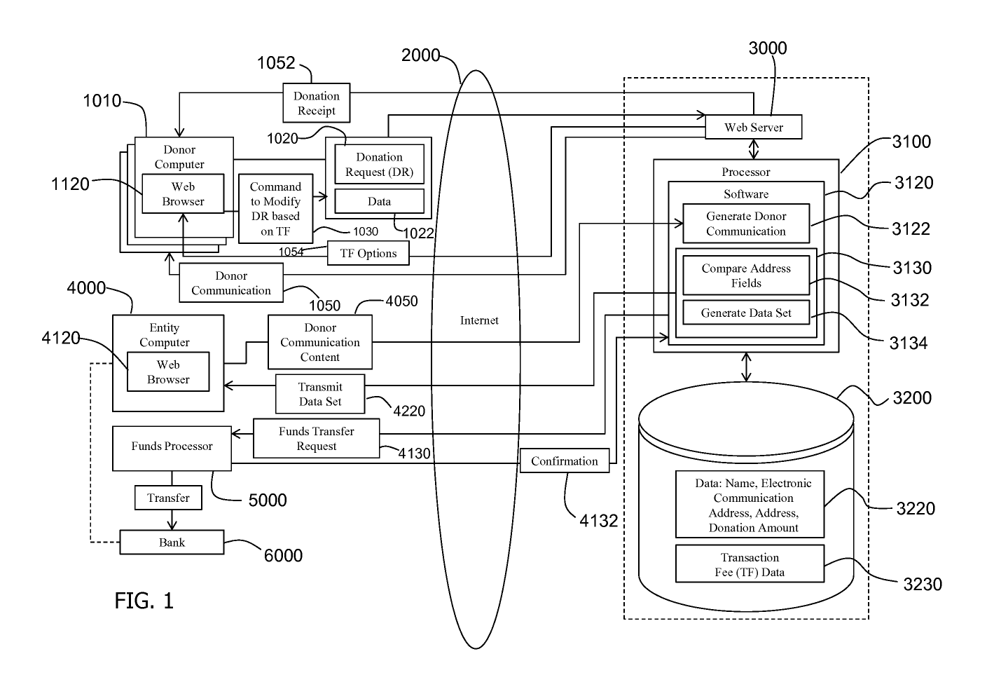

FIG. 1 shows a plurality of donor computers 1010 in communication over the internet 2000 with a web server 3000. A donation request 1020 is transmitted to the web server 3000 and includes data 1022 such as name, electronic communication address, address and donation amount. The data may also contain instructions concerning the purpose of the donation. The web server is in communication with a processor 3100 having software 3120 executing thereon. The web server 3000, processor 3100 and database 3200 may all be contained in a single computer system, alternatively, the processor or database may be located off site of the web server, for example through cloud computing or cloud databases. The software uses the donation request 1020 and associated data 1022 to generate a funds transfer request 4130 that is transmitted over the internet to a funds processor 5000 that verifies the payment and transfers funds to a bank 6000. A confirmation 4132 is transmitted back to the software to confirm successful transfer of funds.

Using the data, the software compares the address field 3132 to generate a data set 3134. For a charity to comply with state solicitation statues, the address field must be hidden from the charity when the donor address is outside the charity's address. However, when the charity's address is in the same state as the donor, the charity may need to report this donation activity. The software and the generated data set account for such rules in a way that reduces the burden on the charity to report donations received from out of state donors. The data received from the donor computer is stored in a database 3200. As discussed previously, the data may contain name, electronic communication address, address and donation amount. Although one database is shown, it is possible to arrange the present invention with multiple databases. For example, some sensitive information such as credit card information may be stored on one database, and the contact information for the donor may be stored on a separate database. With multiple databases, each database may be controlled by one individual or entity, alternatively, different entities may control different databases.

The donation request may also be associated with communications preferences that are likewise stored on the database. The database also has transaction fee data 3230. This data can be queried by the software based on donation amount to determine various transaction fees associated with different funds processors. Although only one funds processor is shown, a plurality of funds processors may be accessible to a donor for processing a transaction. Each funds processor may have different fees that are associated with varying donation amounts. Further, a donor may wish to process their transaction with a specific processor. For example, Paypal or Dwolla are two known funds transfer processors that each may have different fees that depend on donation amount. The webserver upon querying the database of the Transaction Fee data 3230 can transmit the relevant transaction fee options 1054 based on donation amount. These options 1054 can also be associated with a request or option to add the transaction fee to the total donation amount and the donor computer can submit commands 1030 to modify the donation request based on the transaction fee options.

Once donations have been completed, the donor computer can receive or request a donation receipt. The donation receipt may be for an individual donation, alternatively, the donation receipt may be transmitted to the donor for use in tax preparation and reporting more than one donation. The donation receipt may be compliant with IRS charitable contribution reporting requirements. Further, since the web server 3000 hosts a number of charitable events or fundraising projects, the donor can select multiple projects for their donation. The system provides a unified way to manage and track donations. It is further contemplated that the donation receipt 1052 may be sent to the electronic communication address associated with a donor identifier on an annual basis and in anticipation of tax filing deadlines. For example, the system may automatically send a donation receipt on or around January 31 of each calendar year in anticipation of the traditional April 15 tax deadline. The dates may be adjusted according to reporting requirements and tax deadlines. Further, since the data is associated with a donor identifier, in the event of an audit, the data can be queried and receipts can be stored or generated for use in confirming accuracy of tax returns.

Although shown as separate items, the web server 3000, processor 3100 and database 3200 may be in communication with each other over the internet. Alternatively, the web server 3000, processor 3100 and database 3200 may all be contained in one computing system.

Further, the entity computer can transmit donor communication content 4050 to the processor 3100 (alternatively, this can be transmitted to the processor through the web server. The content 4050 is used to generate a donor communication 1050 that updates a donor via electronic communication address of upcoming events for the charity and further entices donations to the charity through the system. The entity computer can also receive the data set that is based on the software comparison 3132. This data set is associated with an entity identifier that allows an entity to access the data set in a manner compliant with state solicitation statutes. The data set can be used to generate targeted donor communications that send communication to a particular group of donors associated with the entity. The web server further includes a user selectable form or page that allows an entity computer to select which donors receive which communications. For example, a range of donation amounts may be used to send a communication to donors who, for example, donate more than $500. Other donation amounts or ranges are contemplated. Further, as shown in the FIG. 1, the donor computer and the entity computer may each access and submit relevant data requests and transmissions using a web browser.

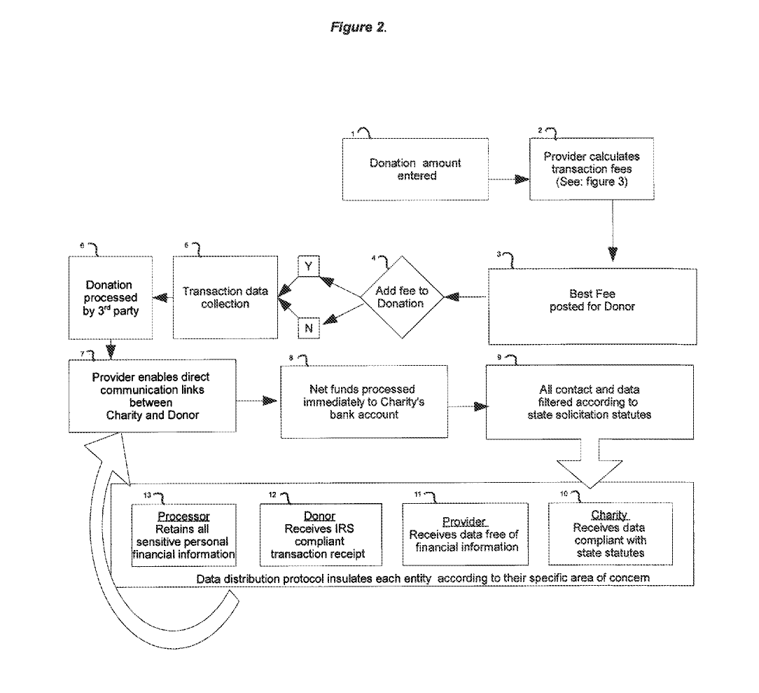

FIG. 2 is a flow chart showing how information or data is collected. A website is created on a web server that provides a form where a donor enters the donation amount 1, and the provider software calculates the transaction fees 2. The best fee is displayed for the donor 3. The best fee typically depends on donation size. The donor has the option of adding the fee to the donation amount 4. The donor then enters transaction data 5, such as credit card information, bank account information or other electronic funds transfer methods. Typically, the security of the transaction requires an address from the donor. Once the transaction data is collected, the donation is processed by the processor 6. The provider enables direct communication links between the charity and the donor 7. The net funds are posted to the charity's account 8. Contact data is filtered to comply with state solicitation statutes 9 by provider software located on a web server or computer in communication with the internet. The software uses rules based on each state and a comparison between the state of the charity and the state of the donor. For example, a donation from a Florida resident to a Florida charity may be reported to the charity including address and all contact information. If a resident outside of Florida donates to a Florida charity, the software does not report the address of the donor to the charity. Typically, this filtering reduces or eliminates the reporting and registration requirements of each state, and the filtering is done through software with rules based on each state. This reduction or elimination results in a significant cost savings for the charity, and makes it easier for smaller charities to raise funds from residents outside the home state of the charity. Once the data is filtered by the software, the charity receives data compliant with state statutes 10. The provider receives data free of financial information 11, such as credit card or bank account information. The donor receives an IRS compliant transaction receipt 12. The processor retains all sensitive personal financial information 13. The data distribution protocol described above insulates each entity according to their specific area of concern. The software allows the charity to decide how often and when they receive information. For example, the charity can be updated when each new donation is completed, daily, weekly, monthly or other time periods chosen by the charity. The software can also provide the charity with a full transaction record and accounting of all the funds received.

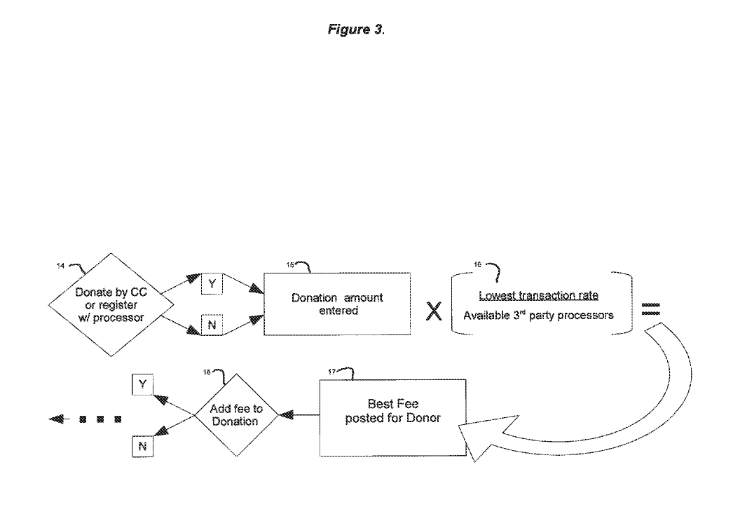

FIG. 3 is a flow chart showing how the best fee shown in FIG. 1 is calculated. The donor chooses to donate by credit card or register with a processor 14. The donation amount is entered 15, and the lowest transaction rate is calculated 16 is based on the donor's choice of funds processing method. The software may query a database having rates for available funds processors. These rates may be based on donation amount. The software can query the database based on donation amount. The fee is the amount that will be taken from the total donation and distributed between the provider and processor. The best fee is posted for the donor 17, and the donor has the option to add the fee to the donation 18. If the donor does not add the fee to the donation, the charity will receive the donation amount less the fee.

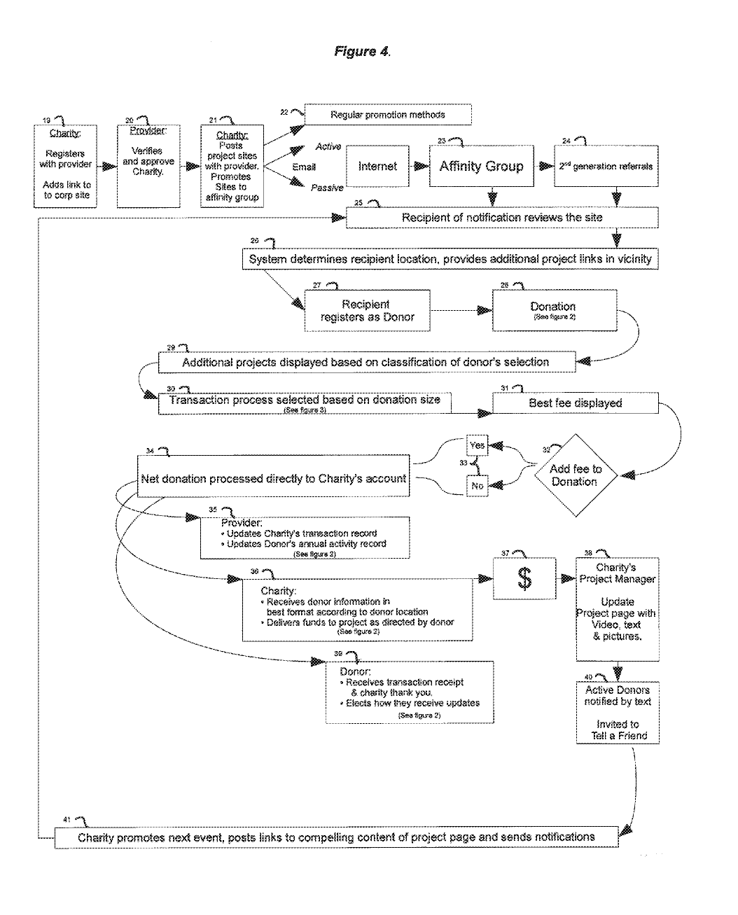

FIG. 4 shows how information collected in FIG. 1 is processed and shielded to comply with solicitation requirements. The Charity registers with the provider and may add the link to the provider to their website 19. The link created is available through the internet and hosted on a web server. The provider verifies and approves the charity 20. Typically the verification includes validating the tax identification and tax exempt status of the charity. The charity can then create a website with the provider and promote the site(s) to a group of followers 21. The website has the software for filtering transaction data loaded onto the server, or the website is in communication with a processor running the filtering software. The charity may promote the website to a group of followers 21 through electronic mail, SMS, MMS, Facebook, Twitter or other electronic communications means. Regular promotion methods 22 such as USPS, UPS, FEDEX, DHL and other courier services may also be used, but courier services may require additional registration or reporting according to state law. An Affinity group 23 can review the website 25, and create a 2^{nd} generation of referrals 24. The affinity group is a list of individuals who receive contact information from the charity. The 2^{nd} generation of referrals can be forwarded a message or link to the charity's website. A recipient of the link reviews the website 25. The provider website determines the location of a potential donor, through the IP address of the potential donor's computer or internet connection. The IP address location is compared through a computer processor or the web server to determine if there are any additional charitable projects in the vicinity of the potential donor. The recipient of the website link can then submit a donation 28 and register as a donor 27. Typically the donation will come first and registration will come after donation, however the system can be configured to require registration first. Additional charitable projects are displayed based on the donor's interests 29. The Transaction is processed based on donation size 30. The best fee is displayed 31, and the donor may add this fee to the donation 32. The donation proceeds are sent to the charity 34. The provider updates the charity's transaction record and the donor's annual activity 35. The charity receives the donor information according to the donor's location, and the funds for the project 36. The donor receives a transaction receipt and a thank you note, update or other promotion from the charity, the donor may also elect to be notified of updates and other events for the charity, and may select various communication preferences 39. After the charity receives donor information and funds, the charity's project manager can update the project page with video, text, pictures and other information about the project 38. Active donors are notified and invited to tell a friend about the charity's project 40 to grow the affinity group. The charity may create a new event and promote the next event through the provider 41, the promotion may be done through the provider according to the donor's selection of update preferences.

In order to provide a donation handling system that overcomes the disadvantages of the prior art, a website is created to display information about the charity to potential donors. Software is in communication with the website to collect data about the donation from a donor. The software is used to filter the data collected from the donor, the data is then distributed to the donor, provider, processor and other parties according to rules based on the state the charity is registered in, and the state of the donor. By distributing only some of the data to the charity, the reporting and registration requirements are reduced so that smaller charities can accept funds from states outside where the charity was originally registered without requiring registration under the state solicitation statutes.

If the charity is not made aware of the physical address of the donor, many state statutes will not require registration or submission of donation reports to the state agency. Without knowing the physical address, the charity has no way of reasonably knowing or inquiring into the address of the donor. By using the provider to keep in contact with donors, the charity is able to increase their visibility among potential donors, but the charity does not need to go through the burdensome expense of registering and tracking all the donations on a state-by-state basis.

The provider hosts or generates the website, stores contact information of donors, generates reports on donation activity, and allows donors to see other charities and projects that may be of interest to the donor. The website may be hosted on the charity's web server. The software for filtering the information is based on a computer or web server that is in communication with the website where a donor may go to donate to the charity.

The processor collects financial data so that a donation can be executed through electronic funds transfer. This processor will accept credit card, bank account or other electronic fund transfer methods. Typically, the processing of electronic funds will require a billing address in the case of credit cards. The donor will enter their financial information with the processor, and when a donation is processed, the provider receives data free of financial information. Software generates a donation receipt, which is transmitted to the donor. This receipt may be complaint with IRS reporting requirements. Software filters data received from the donor and/or processor, and the charity receives data compliant with state solicitation statutes, and the donation amount less any fees. The data is filtered according to rules based on each state's solicitation statutes, and the filtering is accomplished by software that executes on a processor in communication with the Internet. The software may also be located on the web server where the website is hosted, or on a secondary web server that is in communication with the provider or charity web server where the donation or project page is hosted.

The filtered data will typically not include the state or physical address of the donor. By shielding the physical address of the donor from the charity, the charity has reduced reporting and registration requirements. The registration and reporting requirements are reduced because the charity is not made aware of the physical address of the donor, thus charity has not solicited from an out of state donor. The reduction of these requirements allows for the charity a significant cost savings to doing business in a state outside their home state.

A website is used for the charity to promote their cause or projects and accept donations. The software for filtering information may be located on a web server or a computer that may communicate with the website. The website provides a place where the charity can post text, video and photo among other information. This information is used to tell potential donors about the charity and entice a donation. Many of the donations accepted will be executed through the Internet, using a credit card, bank account or other electronic transfer of funds. There are a number of funds processors available to complete electronic funds transfers, and each processor has a different fee. The website allows the donor to choose the processor with the lowest fee based on the donation amount, and the fee may be added to the donation total. The website also accepts information other than the address of the donor. For example, e-mail, phone number, facebook page, twitter account or other electronic communication methods.

A single party may take the role of both the provider and the processor, but the data will still be filtered so that the charity's state registration and reporting requirements are reduced. By signing up with the provider, the charity has an account with at least one transaction processor. The donor has the option to use a credit card or register with a third party transaction processor to access a lower transaction and processing fee.

A charity will wish to keep in contact with donors, but avoid directly soliciting for donations. The provider may initiate this contact through electronic methods such as, e-mail, SMS, Facebook, Twitter or other electronic communication methods. The provider may also communicate through the mail with USPS or a courier service such as UPS, DHL, FEDEX or others. When a donor registers with the provider, the donor can select communication preferences that allow the donor to be updated on projects based on charity, interest area, location or other filters. Provider software can notify the donor of projects that may interest the donor through e-mail or other electronic communication methods.

By not reporting the donor location or the specific dollar amount raised per state the system and software has allowed the charity to stay in contact with all donors through the provider while preserving the donor's geographic anonymity. The geographic anonymity avoids the occurrence of a direct solicitation by the charity, thus reducing the reporting and registration requirements of the charity.

What is claimed is:

1. A system for processing and filtering donation information received from a donor comprising:
a processor;
data transmitted to said processor over the internet and indicative of a donation request;
a database storing said data;
said data including a plurality of fields;
a funds transfer request generated by software executing on said processor, said funds transfer request generated based on said data and associated with an entity identifier;
an address of said entity compared with an address field of said data by said software to generate a first data set having a plurality of records;
each record excluding address field when said address of said entity and said address field include different states;
said first data set associated with said entity by said entity identifier and accessible by a computer associated with said entity identifier.

2. The system of claim 1 further comprising:
a plurality of fee records stored in a database, each said plurality of fee records corresponding to a transaction fee associated with an amount of a funds transfer request;
said donation amount field compared with said plurality of fee records by said software to determine the transaction fee associated with a donation amount.

3. The system of claim 1 further comprising:
a plurality of fee records stored in a database, each said plurality of fee records corresponding to a transaction fee associated with an amount of a funds transfer request and associated with a plurality of funds transfer processors;
said software comparing a donation amount field with said plurality of records to determine the transaction fee associated with said donation amount for each funds transfer processor to create transaction fee data and to generate a request;
said request transmitted to a web browser of a donor computer.

4. The system of claim 3 wherein when said transaction fee data is displayed on said website, one said funds transfer processors is user selectable.

5. The system of claim 3 further comprising:
a request generated by said software and transmitted to said web server for display, said request requesting a increase of said donation amount based on said transaction fee;
a response received by said software, said donation request modified by said software based on said response.

6. The system of claim 1 further comprising:
a web server accessible based on said entity identifier;
said entity identifier associated with said first data set;
said web server receiving content from an entity computer for transmission to an electronic communications address associated with each said record.

7. The system of claim 1 wherein the computer accessing said data set is an entity computer.

8. The system of claim 1 further comprising:
content transmitted to said processor by said computer;
a communication generated based on said content and said data and transmitted to a plurality of electronic communication addresses associated with said entity identifier.

9. A system for processing and filtering donation information received from donors comprising:
a processor with software executing thereon;
an interface in communication with a donor computer via a web server, the interface for selecting one or more entities;
a database storing a plurality of data sets received from a plurality of donor computers each said data set indicative of one or more donations, each donation associated with a donor identifier and an entity identifier;
each said data set including a plurality of fields, said fields including at least name, donation amount, address and electronic communication address;
said software generating a donation receipt based on each said data set associated with said donor identifier;
said database storing each donation receipt and accessible by a donor computer.

10. The system of claim 9 wherein said receipt is compliant with Internal Revenue Service requirements for reporting a charitable donation.

11. The system of claim 9 further comprising:
a receipt generated by said software;
said receipt including each donation associated with said donor identifier during a calendar year;
said receipt transmitted to said donor computer.

12. The system of claim 9 wherein said form is compliant with Internal Revenue Service requirements.

13. The system of claim 9 wherein said software automatically transmits said donation receipt on an annual basis.

14. The system of claim 9 further comprising a receipt request received by said web server and said software generating said receipt in response to said receipt request and said web server is accessible based on said donor identifier for transmission of said receipt.

15. A method for managing charitable contributions with a website comprising the steps of:
providing a database;
providing a web server in communication said database and having software executing thereon;
receiving data transmitted to said web server from a donor computer, said data indicative of a donation request, said data received by said database;
comparing an address of said entity with an address field of said data via said software;
generating a plurality of records via said software to create a first data set, each said record excluding address field when said address of said entity and said address field include different states;
associating said first data set with said entity by said entity identifier; and
transmitting said first data set to a web server, said first data set accessible based on an entity identifier.

16. The method of claim 15 further comprising the steps of:
receiving a receipt request via a donor computer, said request including a donor identifier;
generating a receipt based on said donor identifier;
transmitting said receipt to said web server;

17. The method of claim 16 wherein said donor identifier is said electronic communication address.

18. The method of claim 16 further comprising the steps of transmitting a communication generated by said software to an electronic communication address associated with said donor identifier.

19. The method of claim 16 wherein said data includes at least: name, address, electronic communication address and donation amount.
